(19) United States
(12) Patent Application Publication
(10) Pub. No.: US 2025/0164632 A1
(43) Pub. Date: May 22, 2025

(54) OBJECT DETECTION DEVICE AND OBJECT DETECTION METHOD

(71) Applicant: AISIN CORPORATION, Kariya, Aichi (JP)

(72) Inventors: Hideaki HIROSE, Kariya-shi, Aichi-ken (JP); Koji NAGASE, Kariya-shi, Aichi-ken (JP); Eiji ITAMI, Kariya-shi, Aichi-ken (JP); Kenichi TAGUCHI, Kariya-shi, Aichi-ken (JP)

(73) Assignee: AISIN CORPORATION, Kariya, Aichi (JP)

(21) Appl. No.: 18/841,524

(22) PCT Filed: Apr. 20, 2023
(86) PCT No.: PCT/JP2023/015771

§ 371 Date: Aug. 26, 2024

(30) Foreign Application Priority Data
May 18, 2022 (JP) 2022-081850

(51) Int. Cl. G01S 13/89; E05F 15/40; G01S 13/931; G06T 7/73

(52) U.S. Cl. CPC G01S 13/89; E05F 15/40; G01S 13/931; G06T 7/73; E05Y 2400/54; E05Y 2900/531; G06T 2207/30261

(57) ABSTRACT

An object detection device according to an embodiment generates, in a learning phase, an object detection model by performing machine learning of a relationship between a feature vector indicating a distribution shape of a detection point cloud based on a reflected wave of a probing wave transmitted from a sensor and reflected by the object, and information indicating whether the object is an obstacle. In an estimation phase, the object detection device then calculates a detection point cloud as a position of the object on the basis of the plurality of acquired reception results, calculates a feature vector indicating a distribution shape of the detection point group on the basis of the calculated detection point cloud, determines whether the object is an obstacle on the basis of the calculated feature vector and the object detection model, and outputs a determination result.

### CROSS REFERENCE TO RELATED APPLICATIONS

This application is a National Stage of International Application No. PCT/JP2023/015771 filed Apr. 20, 2023, claiming priority based on Japanese Patent Application No. 2022-081850 filed May 18, 2022, the entire contents of which are incorporated in their entirety.

### TECHNICAL FIELD

An embodiment of the present disclosure relates to an object detection device and an object detection method.

### BACKGROUND ART

Research and development of an automatic door system that automatically opens and closes a door of a vehicle (automobile) through an operation by an occupant or a person who is about to get in the vehicle have been and are being made. It is essential for an automatic door system to have properties that prevent a door from colliding with an obstacle (such as a person or another vehicle) during a door opening operation. Hereinafter, a door that automatically opens and closes will be also referred to as an “automatic door”. Also, in the description below, the door is assumed to be a swing door.

To achieve the above properties, there is a method for providing an object detection sensor (such as a millimeter wave radar) inside an automatic door, estimating the position of an obstacle on the basis of a detection point cloud obtained by sensing, and performing control so that the door does not collide with the obstacle, for example.

By this method, the position of the obstacle can be estimated (calculated) from geometric information about the detection point cloud captured by the object detection sensor. As a result, it becomes normally possible to calculate an opening movable angle (an openable angle) of the automatic door, and cause the automatic door to perform an opening operation so as not to collide with the obstacle.

### CITATION LIST

### Patent Literatures

Patent Literature 1: JP 2016-134090 A
Patent Literature 2: JP 2003-271975 A
Patent Literature 3: JP 6261489 B1

### SUMMARY OF THE DISCLOSURE

### Technical Problems

By the above conventional technique, however, a problem might occur depending on the surrounding environments such as a road surface. For example, on road surfaces of some types such as asphalt road surfaces, many detection points appear even in the absence of obstacles. Because of this, an error in the detected position might become larger when there is an obstacle, or the existence of an obstacle might be erroneously determined even though there are no obstacles.

That is, when a detection point cloud including noise to a certain degree or higher is used, the opening operation of the door might be stopped in a situation where the distance to an obstacle is still long, or the opening operation is not performed at all though the door can be opened.

Therefore, the present disclosure provides an object detection device and an object detection method that can detect an obstacle around a vehicle with high accuracy, regardless of surrounding environments such as a road surface.

### Solutions to Problems

An object detection device according to an embodiment of the present disclosure includes: an acquisition part that acquires a plurality of results of reception of a reflected wave generated when a probing wave transmitted from a sensor installed in a door of a vehicle is reflected by an object around the vehicle; and, in a learning phase, a model generation part that calculates a detection point cloud as a position of the object on the basis of the plurality of results of reception acquired by the acquisition part, and generates an object detection model by performing machine learning of a relationship between a feature vector indicating a distribution shape of the detection point cloud and information indicating whether the object is an obstacle: in an estimation phase, a first calculation part that calculates a detection point cloud as a position of the object, on the basis of the plurality of results of reception acquired by the acquisition part: a second calculation part that calculates a feature vector indicating a distribution shape of the detection point cloud, on the basis of the detection point cloud calculated by the first calculation part; and an estimation part that determines whether the object is an obstacle on the basis of the feature vector calculated by the second calculation part and the object detection model, and outputs a determination result, for example.

In this configuration, an object detection model generated beforehand by machine learning is used, so that an obstacle around the vehicle can be detected with high accuracy, regardless of the surrounding environments such as a road surface.

Also, in the object detection device, the model generation part performs coordinate transform of the detection point cloud into three-dimensional coordinates based on the door in which the sensor is installed, sets at least one region of interest on the basis of the detection point cloud in the three-dimensional coordinates, and calculates, as input data, a feature vector indicating a distribution shape of the detection point cloud in the set region of interest, and the second calculation part performs coordinate transform of the detection point cloud calculated by the first calculation part into the three-dimensional coordinates, sets at least one region of interest on the basis of the detection point cloud in the three-dimensional coordinates, and calculates a feature vector indicating a distribution shape of the detection point cloud in the set region of interest, for example.

With this configuration, a more specific process of calculating the feature vector indicating the distribution shape of a detection point cloud by setting a region of interest in three-dimensional coordinates based on the door can be performed.

Further, in the object detection device, the door is a swing door, for example, the object detection device further includes a control part that controls a driver unit that causes the door to perform an opening or closing operation, and, when the estimation part outputs information indicating that the object is an obstacle, the control part sets an opening movable angle of the door on the basis of positional information about the obstacle, and controls the drive unit to cause the door to perform an opening operation to the set opening movable angle.

In this configuration, the door is made to perform an opening operation up to the set opening movable angle, so that a collision between the door and an obstacle can be avoided, and the door is prevented from stopping the opening operation at an unnecessarily early stage.

Further, in the object detection device, the control part controls the drive unit to cause the door to perform an opening operation to the set opening movable angle, on the basis of a request for an automatic opening operation of the door from the user of the vehicle, for example.

With this configuration, the user of the vehicle can conduct a predetermined operation in response to a request for an automatic opening operation of the door, so that the door can be made to perform an opening operation.

Meanwhile, an object detection method according to the present embodiment includes: an acquisition step of acquiring a plurality of results of reception of a reflected wave generated when a probing wave transmitted from a sensor installed in a door of a vehicle is reflected by an object around the vehicle; and, in a learning phase, a model generation step of calculating a detection point cloud as a position of the object on the basis of the plurality of results of reception acquired in the acquisition step, and generating an object detection model by performing machine learning of a relationship between a feature vector indicating a distribution shape of the detection point cloud and information indicating whether the object is an obstacle; in an estimation phase, a first calculation step of calculating a detection point cloud as a position of the object, on the basis of the plurality of results of reception acquired in the acquisition step: a second calculation step of calculating a feature vector indicating a distribution shape of the detection point cloud, on the basis of the detection point cloud calculated in the first calculation step; and an estimation step of determining whether the object is an obstacle on the basis of the feature vector calculated in the second calculation step and the object detection model, and outputting a determination result, for example.

In this configuration, an object detection model generated beforehand by machine learning is used, so that an obstacle around the vehicle can be detected with high accuracy, regardless of the surrounding environments such as a road surface.

An object detection method according to an embodiment of the present disclosure includes: an acquisition step of acquiring a plurality of results of reception of a reflected wave generated when a probing wave transmitted from a sensor installed in a swing door of a vehicle is reflected by an object around the vehicle; and, in a learning phase, a model generation step of calculating a detection point cloud as a position of the object on the basis of the plurality of results of reception acquired in the acquisition step, and generating an object detection model by performing machine learning of a relationship between a feature vector indicating a distribution shape of the detection point cloud and information indicating whether the object is an obstacle; in an estimation phase, a first calculation step of calculating a detection point cloud as a position of the object, on the basis of the plurality of results of reception acquired in the acquisition step: a second calculation step of calculating a feature vector indicating a distribution shape of the detection point cloud, on the basis of the detection point cloud calculated in the first calculation step; an estimation step of determining whether the object is an obstacle on the basis of the feature vector calculated in the second calculation step and the object detection model, and outputting a determination result; and a control step of, when information indicating that the object is an obstacle is output from the estimation step, setting an opening movable angle of the door on the basis of positional information about the obstacle, and controlling a drive unit that causes the door to open or close, to cause the door to perform an opening operation to the set opening movable angle, for example.

In this configuration, an object detection model generated beforehand by machine learning is used, so that an obstacle around the vehicle can be detected with high accuracy, regardless of the surrounding environments such as a road surface. Also, the door is made to perform an opening operation up to the set opening movable angle, so that a collision between the door and an obstacle can be avoided, and the door is prevented from stopping the opening operation at an unnecessarily early stage.

### BRIEF DESCRIPTION OF DRAWINGS

FIG. 1 is an external view of a vehicle on which a sensor unit of an embodiment is mounted, as viewed from a side.

FIG. 2 is a functional configuration diagram of an automatic door system according to the embodiment.

FIG. 3 is a functional configuration diagram of a DSP according to the embodiment.

FIG. 4 is a flowchart illustrating an overall process to be performed by the automatic door system according to the embodiment.

FIG. 5 is a flowchart illustrating details of the process in step S13 in FIG. 4.

FIG. 6 is a flowchart illustrating details of a process as a modification of step S13 in FIG. 4.

FIG. 7 is a flowchart illustrating details of the process in step S202 in FIG. 5.

FIG. 8 is a diagram illustrating an example of a detection point cloud in a case where there is an obstacle in the embodiment.

FIG. 9 is a diagram illustrating an example of a detection point cloud in a case where there are no obstacles in the embodiment.

FIG. 10 is a diagram illustrating an example of setting of a region of interest in a case where there is an obstacle in the embodiment.

FIG. 11 is a diagram illustrating an example of setting of a region of interest in a case where there are no obstacles in the embodiment.

FIG. 12 is a diagram illustrating an example of a feature amount extracted in a case where there is an obstacle in the embodiment.

FIG. 13 is a diagram illustrating an example of a feature amount extracted in a case where there are no obstacles in the embodiment.

FIG. 14 is a diagram illustrating examples of feature vectors created in the embodiment.

FIG. 15 is a graph for comparing two feature vectors in the embodiment.

FIG. 16 is a comparison table illustrating performance of a plurality of machine learning devices determining the presence or absence of an object in the embodiment.

FIG. 17 is a flowchart illustrating details of the process in step S204 in FIG. 5.

FIG. 18 is an explanatory diagram of calculation of a door movable angle in the embodiment.

FIGS. 19A-19B is an explanatory diagram of object type determination based on statistics of distributions of detection point clouds in the embodiment.

FIGS. 20A-20B is an explanatory diagram of object type determination based on geometric features of distributions of detection point clouds in the embodiment.

FIG. 21 is an explanatory diagram of object type determination based on reflection energy values of distributions of detection point clouds in the embodiment.

FIG. 22 is a comparison table showing performance of a plurality of machine learning devices determining object types in the embodiment.

### DESCRIPTION OF EMBODIMENTS

In the description below, an embodiment of an object detection device and an object detection method of the present disclosure will be described. The configuration of the embodiment disclosed below, as well as the actions, results, and effects to be achieved by the configuration, are merely examples. The present disclosure can be embodied by configurations other than the configuration disclosed in the embodiment below, and can achieve at least one of the various effects based on the basic configuration and the derivative effects.

Note that, in the embodiment below, a case where “supervised learning (learning using training data)” is adopted as an example of machine learning will be described. Further, as for machine learning, a learning scene will be referred to as a “learning phase”, and an estimation scene will be referred to as an “estimation phase”.

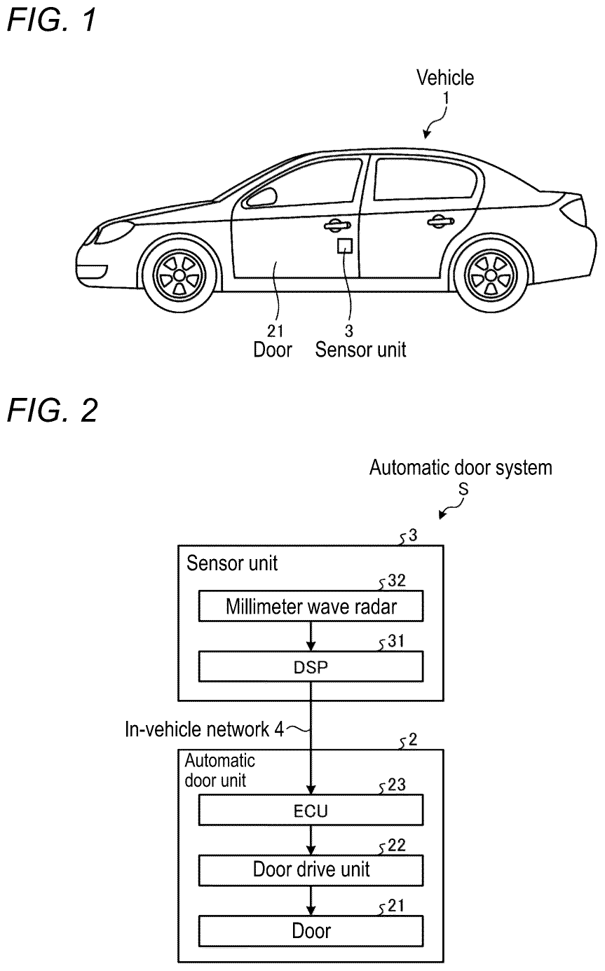

FIG. 1 is an external view of a vehicle 1 on which a sensor unit 3 of the embodiment is mounted, as viewed from a side. FIG. 2 is a functional configuration diagram of an automatic door system S according to the embodiment.

As illustrated in FIG. 1, the sensor unit 3 is installed at a predetermined position in a swing door 21 of the vehicle 1. Millimeter waves that are used in the sensor unit 3 are reflected and absorbed by metal, but are likely to pass through plastic resin. Therefore, the sensor unit 3 is preferably mounted on a resin portion of the panel of the door 21. Although the sensor unit 3 is installed only in one door 21 in FIG. 1 for the ease of illustration and explanation, the present disclosure is not limited to this, and the sensor unit may be installed in two or more doors.

Further, as illustrated in FIG. 2, the automatic door system S includes the sensor unit 3 and an automatic door unit 2. One automatic door system S is provided for one door 21.

The sensor unit 3 is a means that detects an obstacle hindering an automatic opening operation of the door 21. The sensor unit 3 includes a digital signal processor (DSP) 31 and a millimeter wave radar 32 (a sensor).

The millimeter wave radar 32 is a sensor component that transmits a millimeter wave (a radio wave in a frequency band of 30 to 300 GHz) to the surroundings, receives a reflected millimeter wave, and generates and outputs an intermediate frequency (IF) signal obtained by mixing both waves. Note that output information from the millimeter wave radar 32 is converted into a digital signal by an analog-digital conversion circuit. In recent years, the millimeter wave radar 32 has been reduced in size and thickness, and can be easily embedded in the door 21 of the vehicle 1.

The DSP 31 calculates the position, the velocity, and the like of an obstacle, on the basis of the IF signal output from the millimeter wave radar 32. The DSP 31 is a device that performs special signal processing. Since the DSP 31 is a type of computer, it is also possible to add and execute a program that further performs special signal processing on the basis of calculation information.

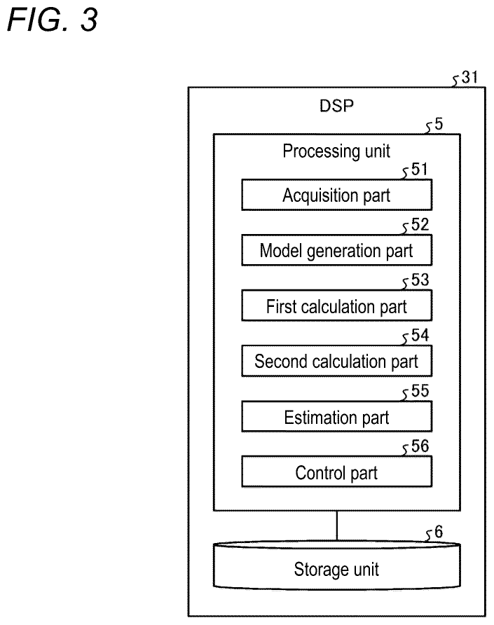

Here, FIG. 3 is a functional configuration diagram of the DSP 31 according to the embodiment. As illustrated in FIG. 3, the DSP 31 includes a processing unit 5 and a storage unit 6.

The storage unit 6 stores a program to be executed by the processing unit 5, and data necessary for executing the program. For example, the storage unit 6 stores an object detection program to be executed by the processing unit 5, numerical data necessary for execution of the object detection program, door trajectory data, and the like. The storage unit 6 is formed with a read only memory (ROM), a random access memory (RAM), or the like, for example. The ROM stores programs, parameters, and the like. The RAM temporarily stores various kinds of data to be used in calculation in the central processing unit (CPU).

The processing unit 5 calculates the position and the like of an object on the basis of information output from the millimeter wave radar 32. The processing unit 5 is designed as a function of the CPU, for example. The processing unit 5 includes, as functional components, an acquisition part 51, a model generation part 52, a first calculation part 53, a second calculation part 54, an estimation part 55, and a control part 56. The processing unit 5 operates as each functional component by reading the object detection program stored in the storage unit 6, for example. Alternatively, part or all of each functional component may be formed with hardware such as an application specific integrated circuit (ASIC) or a circuit including a field-programmable gate array (FPGA).

The acquisition part 51 acquires various kinds of information from various components. For example, the acquisition part 51 acquires, from the millimeter wave radar 32, a plurality of results of reception of reflected waves generated by reflection of millimeter waves (probing waves) transmitted from the millimeter wave radar 32 by an object around the vehicle 1.

In a learning phase, the model generation part 52 calculates a detection point cloud as the position of an object on the basis of the plurality of reception results acquired by the acquisition part 51, and generates an object detection model by performing machine learning of the relationship between a feature vector indicating the distribution shape of the detection point cloud and information indicating whether the object is an obstacle. In that case, the model generation part 52 performs coordinate transform of the detection point cloud into three-dimensional coordinates based on the door 21 in which the sensor unit 3 is installed, sets at least one region of interest on the basis of the detection point cloud in the three-dimensional coordinates, calculates the feature vector indicating the distribution shape of the detection point cloud in the set region of interest, and sets the feature vector as input data (this aspect will be described later in detail).

In an estimation phase, the first calculation part 53, the second calculation part 54, and the estimation part 55 perform the following processes.

The first calculation part 53 calculates a detection point cloud as the position of an object on the basis of a plurality of reception results newly acquired by the acquisition part 51.

The second calculation part 54 calculates a feature vector indicating the distribution shape of the detection point cloud, on the basis of the detection point cloud calculated by the first calculation part 53. In that case, the second calculation part performs coordinate transform of the detection point cloud calculated by the first calculation part 53 into three-dimensional coordinates, sets at least one region of interest on the basis of the detection point cloud in the three-dimensional coordinates, and calculates the feature vector indicating the distribution shape of the detection point cloud in the set region of interest (this aspect will be described later in detail). The estimation part 55 determines whether the object is an obstacle on the basis of the feature vector calculated by the second calculation part 54 and the object detection model, and outputs a determination result.

The control part 56 performs various kinds of control. For example, in a case where the estimation part 55 outputs information indicating that the object is an obstacle as a determination result, the control part 56 calculates an opening movable angle (hereinafter also referred to as the “door movable angle”) of the door 21, on the basis of positional information about the obstacle (this aspect will be described later in detail).

The DSP 31 outputs the processed information to the automatic door unit 2 via an in-vehicle network 4. The in-vehicle network 4 is a controller area network (CAN), a CAN-flexible data rate (CAN-FD), or the like, for example.

Referring back to FIG. 2, the automatic door unit 2 is a means that controls an opening/closing operation of the door 21, on the basis of obstacle detection information supplied by the sensor unit 3. The automatic door unit 2 includes the door 21, a door drive unit 22 (a drive unit that opens and closes the door), and an electronic control unit (ECU) 23.

The door drive unit 22 is an electric component that opens and closes the door 21.

The ECU 23 is a device that performs special signal processing for determining a method for controlling the door 21, on the basis of the information received from the DSP 31. Since the ECU 23 is a type of computer, it is also possible to add and execute a program that additionally performs special signal processing.

The ECU 23 is a control unit that executes various kinds of control. The ECU 23 controls the door drive unit 22 installed in the hinge portion of the door 21. The ECU 23 controls the door drive unit 22 so that the door 21 opens to the door movable angle that has been set by the DSP 31, for example.

Further, the ECU 23 controls the door drive unit 22 so that the door 21 performs an opening operation up to the set opening movable angle, on the basis of a request for an automatic opening operation of the door 21 from the user of the vehicle 1, for example.

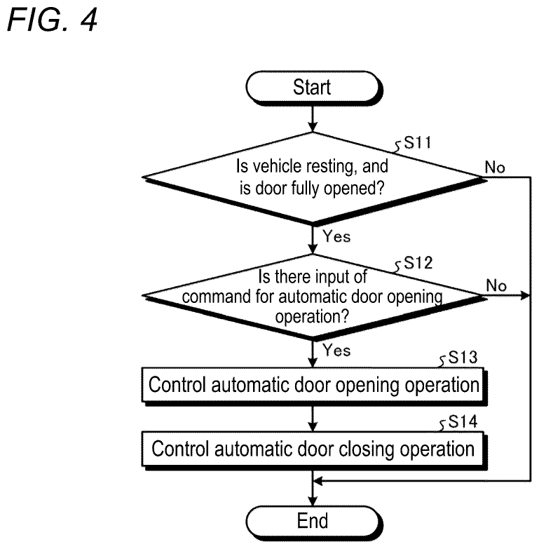

Next, FIG. 4 is a flowchart illustrating an overall process to be performed by the automatic door system S according to the embodiment. First, an outline thereof is described. It is assumed that this overall process is started when the user of the vehicle 1 puts the vehicle 1 into an active state, and is continued while the vehicle 1 is in the active state. Also, when the user of the vehicle 1 puts the vehicle 1 into an inactive state, this overall process is also stopped. However, in a case where the vehicle 1 is running, or the vehicle 1 is in a resting state to lower the consumption of electric energy, the overall process may be temporarily stopped.

First, in step S11, the automatic door system S determines whether the vehicle 1 is resting, and the door 21 to be opened is fully closed. If Yes, the process moves on to step S12, and, if No, the process comes to an end. As the automatic door opening operation is performed under such conditions, safety can be ensured.

In step S12, the automatic door system S determines whether a command for execution of an automatic door opening operation has been input by the user. If Yes, the process moves on to step S13, and, if No, the process comes to an end. Here, the user means a person who is located in the inside or the outside of the vehicle 1 (hereinafter also referred to as “inside or outside the vehicle”), and is able to operate the vehicle 1. For example, the user may be a person who is inside or outside the vehicle, and is in a position to support another person to get on or off the vehicle, or may be a person who actually gets on or off the vehicle 1. Further, when the vehicle is a self-driving vehicle, artificial intelligence responsible for vehicle control may correspond to the user.

Meanwhile, as for the method for inputting a command for an automatic door opening operation, it is assumed that selection can be made from among pressing of a button provided in a key fob, an in-vehicle dashboard, a dedicated application of a smartphone, or the like, execution of a predetermined utterance or gesture, and the like.

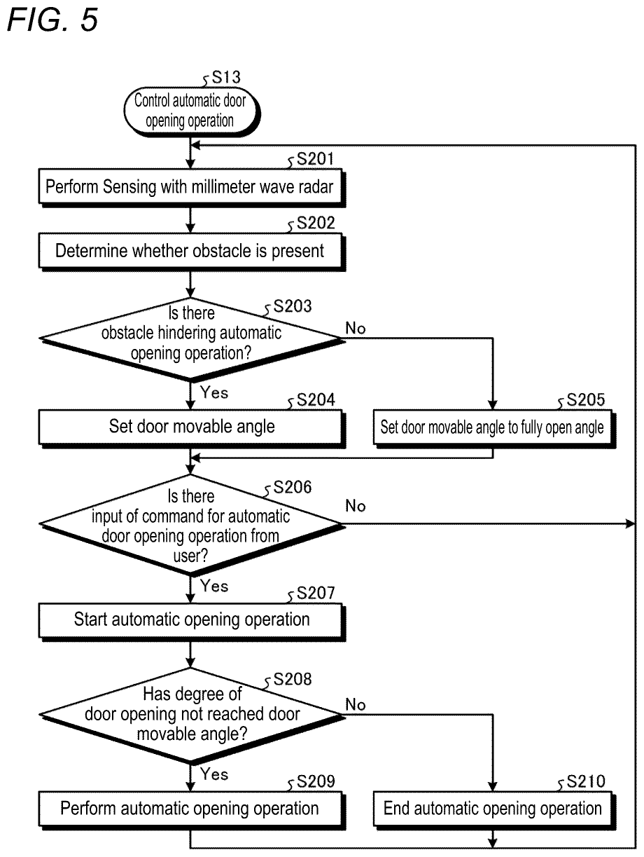

In step S13, the automatic door system S performs an automatic door opening operation (this aspect will be described later in detail, with reference to FIG. 5).

Next, in step S14, the automatic door system S performs an automatic door closing operation. Note that the door closing operation may be manually performed by the user or some other person. Further, when the vehicle is a self-driving vehicle, the artificial intelligence may close the door, after recognizing completion of entering or exiting of a person. After the door 21 is fully closed, the operation flow returns, to prepare for the next automatic door opening operation or the like.

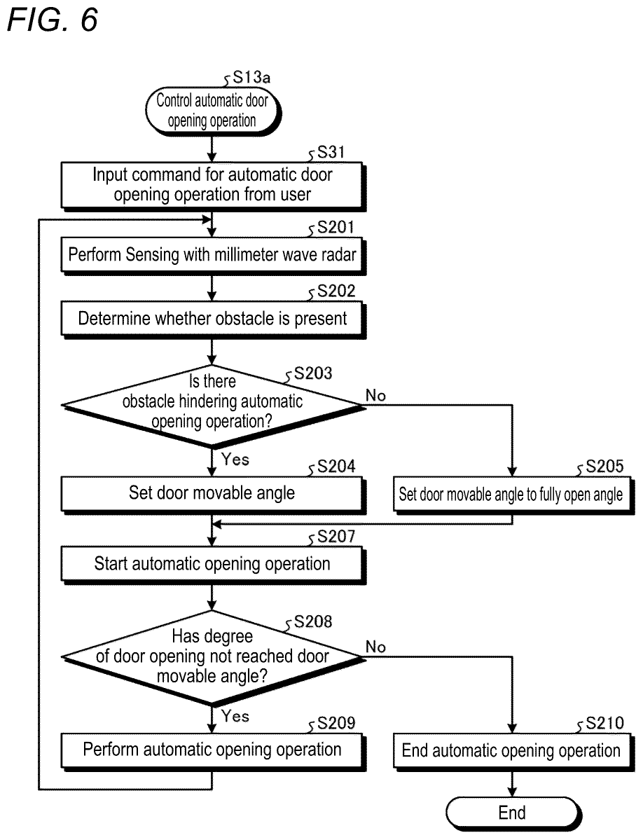

Next, the process in step S13 in FIG. 4 is described in detail, with reference to FIGS. 5 and 6. Note that FIG. 5 is an example of a case of a full-time operation type, and FIG. 6 is an example of a case of an event-driven type (this aspect will be described later in detail).

FIG. 5 is a flowchart illustrating details of the process in step S13 in FIG. 4. The process flow in FIG. 5 is periodically continued while the vehicle 1 is in an active state. What is important in this process flow is that, regardless of the presence or absence of a command input for an automatic door opening operation by the user (Yes/No in step S12 in FIG. 4), obstacle detection by the millimeter wave radar 32 (steps S201 to S205 in FIG. 5) is constantly performed during the overall process in FIG. 4. In the following, this flow is specifically described.

In step S201, sensing is performed by the millimeter wave radar 32. That is, the millimeter wave radar 32 detects an obstacle that is located near the trajectory of opening of the door 21 and has a possibility of colliding with the door 21. The obstacle may be a person, a vehicle, a curb, a wall of a building, or the like, for example.

Next, in step S202, the estimation part 55 of the DSP 31 determines the presence or absence of an obstacle, on the basis of sensing data obtained by the millimeter wave radar 32. Here, the distribution form of the detection point cloud captured by the millimeter wave radar 32 is used as a material for determining the presence or absence of an obstacle (this aspect will be described later in detail). Note that, although explanation is not made, processing by the first calculation part 53 and the second calculation part 54 is also performed as appropriate.

Next, in step S203, the control part 56 of the DSP 31 determines whether there is an obstacle that hinders an automatic opening operation. If Yes, the process moves on to step S204, and, if No, the process moves on to step S205.

In step S204, the control part 56 of the DSP 31 sets the door movable angle on the basis of positional information about the obstacle. That is, the control part 56 sets the door movable angle to avoiding a collision of the door 21 with an obstacle existing near the trajectory of opening of the door 21 (this aspect will be described later in detail).

In step S205, the control part 56 of the DSP 31 sets the door movable angle to the fully open angle. For example, the control part 56 simply determines that the door movable angle is equal to the fully open value of the door hinge.

Next, in step S206, the ECU 23 determines whether the user has input a command for an automatic door opening operation. If Yes, the process moves on to step S207, and, if No, the process returns to step S201.

In step S207, the ECU 23 starts an operation of automatically opening the door 21 by controlling the door drive unit 22. Specifically, the ECU 23 determines at what speed or acceleration the door 21 is to be opened in accordance with the presence or absence of an obstacle in the vicinity of the trajectory of opening of the door 21 or the current degree of door opening, for example, and controls the door drive unit 22 to open the door 21.

Next, in step S208, the ECU 23 determines whether the degree of opening of the door 21 has not reached the door movable angle. If Yes, the process moves on to step S209, and, if No, the process moves on to step S210.

In step S209, the door drive unit 22 performs an automatic opening operation of the door 21.

In step S210, the door drive unit 22 ends the automatic opening operation of the door 21. That is, a series of automatic door opening operations is ended.

FIG. 6 is a flowchart illustrating details of the process in step S13a, which is a modification of step S13 in FIG. 4. As described above, FIG. 6 illustrates an example of an event-driven type. Steps S201 to S205 and S207 to S210 are the same as those in FIG. 5. The differences from FIG. 5 are that the process flow starts after an input of a command for an automatic door opening operation by the user is performed in step S31, and that step S206 is omitted.

An advantage of the event-driven type lies in that there is no need to constantly perform signal processing, and thus, electric energy consumption by the vehicle 1 can be lowered. However, there is a possibility that the readiness of an opening operation to a request for an automatic door opening operation from the user will become lower.

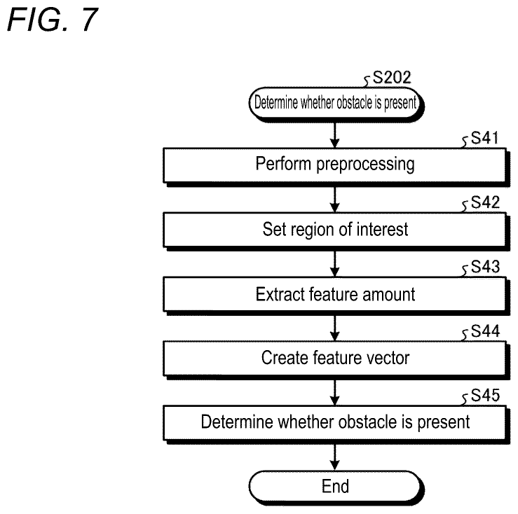

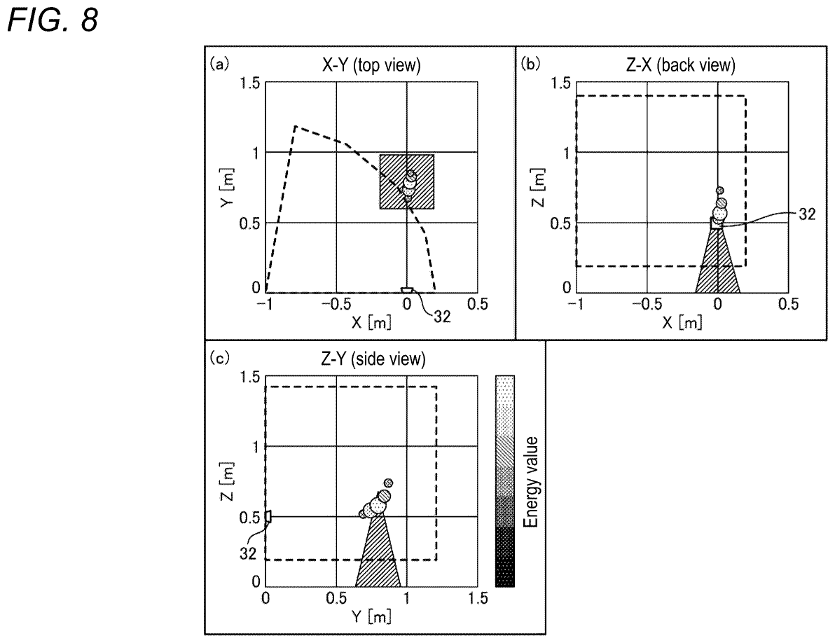

Next, FIG. 7 is a flowchart illustrating details of the process in step S202 in FIG. 5. In step S41, the first calculation part 53 of the DSP 31 calculates, in preprocessing, a detection point cloud as the position of an object, on the basis of a plurality of results of reception performed by the millimeter wave radar 32. For example, the first calculation part 53 calculates the distance, velocity, and angle of the detection point cloud from an IF signal captured by the millimeter wave radar 32. Here, a detection point is one point in a three-dimensional space at which the reflected wave is transmitted back to the millimeter wave radar 32. A plurality of detection points usually appear in one detection operation by the millimeter wave radar 32 (this aspect will be described later with reference to FIG. 8). These detection points are called a detection point cloud.

The detection point cloud may include not only an obstacle such as a real person or a vehicle, but also a noise detection point called a false image or a virtual image. Noise detection points are normally generated as a result of multiple reflection of millimeter waves emitted from the millimeter wave radar 32 by a structure such as a road surface or a building wall. Therefore, in most cases, nothing exists at a point where a noise detection point appears. By conventional techniques, it is not easy to distinguish between a detection point reflecting an actually existing obstacle and a noise detection point, and therefore, the accuracy of determining the presence or absence of an obstacle has been low. To counter this, the processes in and after step S42 are performed in the present embodiment, to increase the accuracy of determining the presence or absence of an obstacle. Note that details of the process in each step will be described later with reference to FIG. 8 and the subsequent drawings.

In step S42, the second calculation part 54 performs coordinate transform of the detection point cloud calculated in step S41 into three-dimensional coordinates, and sets at least one region of interest on the basis of the detection point cloud in the three-dimensional coordinates.

Next, in step S43, the second calculation part 54 calculates the feature amount of the detection point cloud in the set region of interest.

Next, in step S44, the second calculation part 54 calculates a feature vector on the basis of the feature amount.

Next, in step S45, the estimation part 55 determines the presence or absence of an obstacle, on the basis of the feature vector.

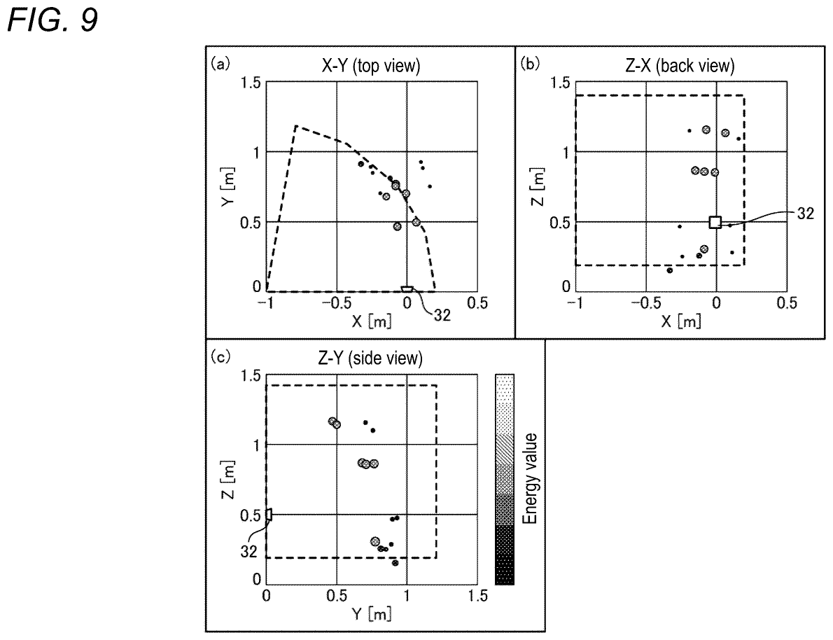

Next, examples of a detection point cloud are described with reference to FIGS. 8 and 9. FIG. 8 is a diagram illustrating an example of a detection point cloud in a case where there is an obstacle in the embodiment. FIG. 8 is an example of detection under a condition that a triangular cone (a gray region) as an obstacle is placed in front of the millimeter wave radar 32 and at a place 60 cm away from the door 21.

Meanwhile, FIG. 9 is a diagram illustrating an example of a detection point cloud in a case where there are no obstacles in the embodiment. FIG. 9 is an example of detection under a condition that there is nothing around the door 21.

In FIGS. 8 and 9, the X-axis is the coordinate axis in the longitudinal direction of the vehicle, the Y-axis is the coordinate axis in the transverse direction of the vehicle, and the Z-axis is the coordinate axis in the vertical height direction. A black broken line in each drawing indicates the trajectory of opening of an automatic door (the door 21). Further, each one circle represents one detection point position. The size and the color of a circle indicate the magnitude of the reflection energy value at the detection point. The data in FIGS. 8 and 9 is obtained on an asphalt road surface. As can be seen from FIGS. 8 and 9, a detection point cloud appears, regardless of whether an obstacle is present or not.

Note that the process of calculating the distance, velocity, and angle of a detection point cloud from an IF signal is the fundamental part of the millimeter wave radar 32, but is not a technical feature of the present embodiment, and therefore, explanation thereof is not made herein. As a result of this process, the polar coordinate values of the distance, the velocity, and the angle in a three-dimensional coordinate system having the center of the millimeter wave radar 32 as its origin (this coordinate system will be hereinafter referred to as the radar coordinate system), and the reflection energy value are obtained for each detection point.

In the process of transform for use in determining the presence or absence of an obstacle, coordinate transform is first performed to transform a radar coordinate system into a three-dimensional coordinate system having the door at its center (hereinafter referred to as the door coordinate system) for each detection point. The origin of the door coordinate system is on the surface of the door 21 of the vehicle 1. If a point that easily collides with an obstacle is selected, it is easy to calculate the door movable angle. In this case, it is necessary to perform calculation to eliminate offsets from the center of the millimeter wave radar 32 embedded in the door 21. Also, in a case where the millimeter wave radar 32 is designed to be inclined inside the door 21, a coordinate rotation process for eliminating the inclination is performed. After the coordinate transform is performed, transform into an orthogonal coordinate system, and a noise reduction process are performed as necessary. In the noise reduction process, a temporal averaging process or spatial averaging process may be performed so as to reduce the noise detection points, for example.

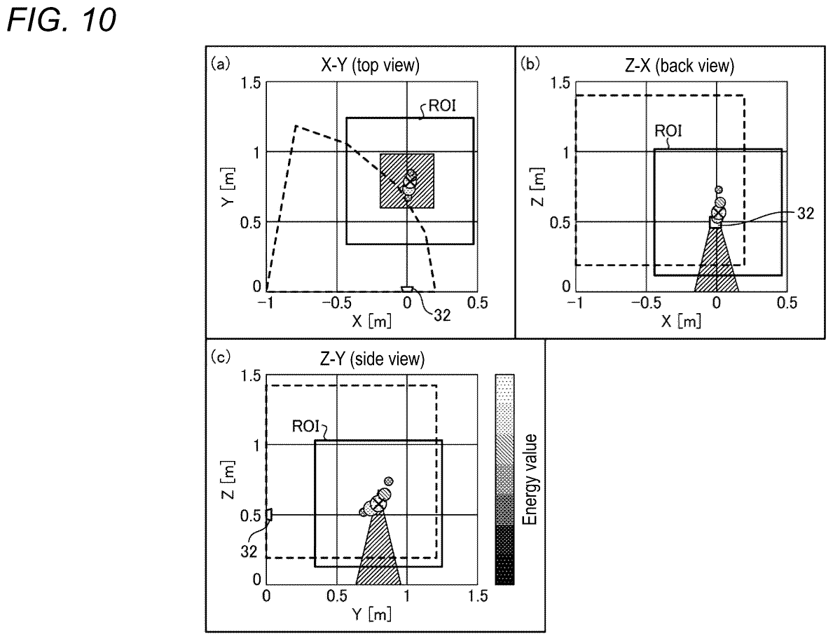

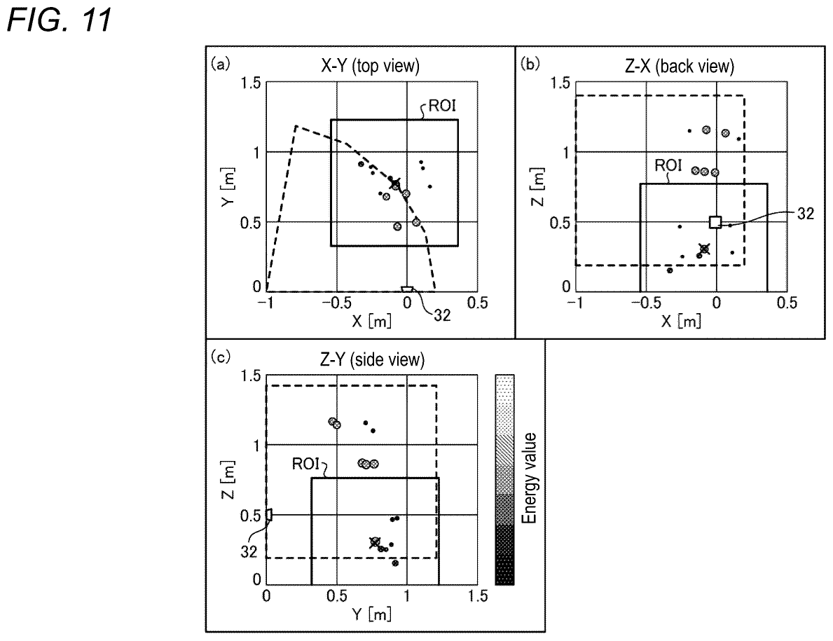

Next, setting of a region of interest is described with reference to FIGS. 10 and 11. FIG. 10 is a diagram illustrating an example of setting of a region of interest in a case where there is an obstacle in the embodiment. FIG. 11 is a diagram illustrating an example of setting of a region of interest in a case where there are no obstacles in the embodiment. In step S42 in FIG. 7, a process of extracting a necessary space is performed to determine the presence or absence of an obstacle. This space is called a region of interest.

FIG. 10 illustrates an example in which a region of interest ROI is set on the basis of the detection point cloud data illustrated in FIG. 8. Also, FIG. 11 illustrates an example in which a region of interest ROI is set on the basis of the detection point cloud data illustrated in FIG. 9. In these examples, the detection point having the highest reflection energy value in the detection point cloud is determined to be the center (marked with x) of the region of interest ROI. Further, the size of the region of interest ROI is a cubic with a side of 0.9 m.

Note that the method for determining the center of the region of interest is not limited to this. For example, a method that adopts the center of gravity, an average value, an intermediate value, or the like of three-dimensional coordinates of a detection point cloud may be used. The manner of determining the center and the size of the region of interest may be determined as appropriate, on the basis of the determination accuracy to be described later, for example. Further, to determine the presence or absence of a plurality of obstacles around the door 21, two or more regions of interest may be set, and a process may be performed on each region of interest.

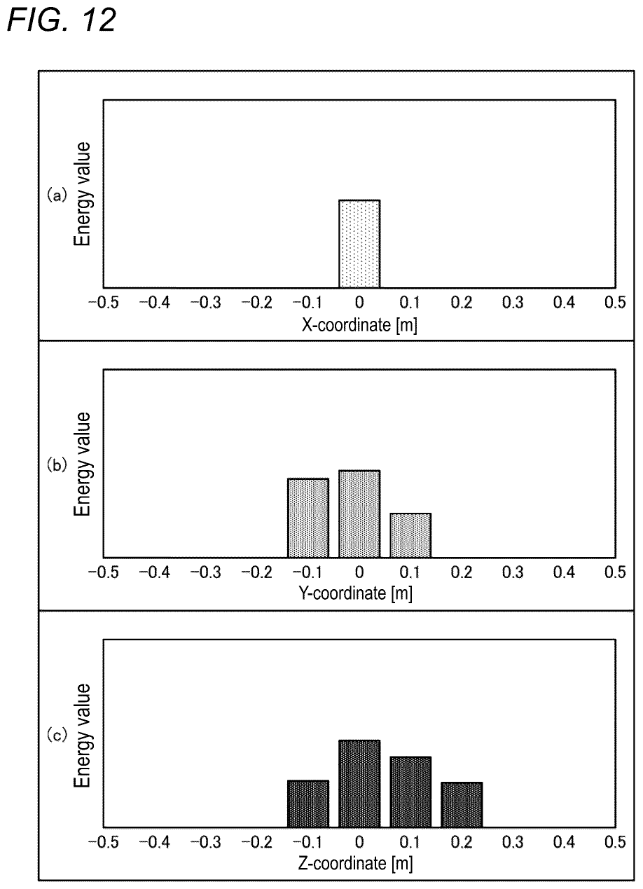

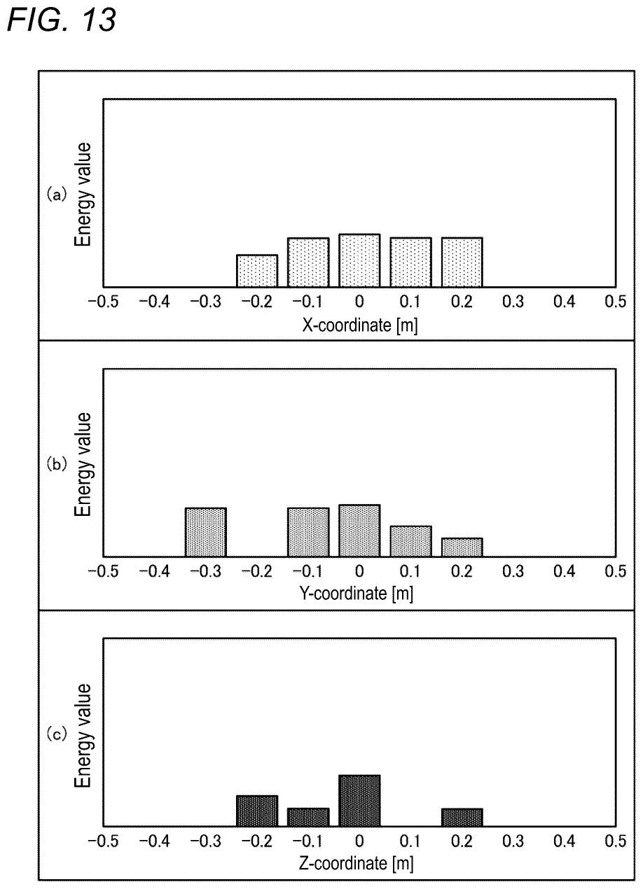

Next, feature amount detection is described with reference to FIGS. 12 and 13. FIG. 12 is a diagram illustrating an example of a feature amount extracted in a case where there is an obstacle in the embodiment. FIG. 13 is a diagram illustrating an example of a feature amount extracted in a case where there are no obstacles in the embodiment.

In step S43 in FIG. 7, as a pre-stage process for determining the presence or absence of an obstacle, a process of extracting features of the distribution form of the detection point cloud in the region of interest is performed. FIG. 12 illustrates an example in which the features of the distribution form of the detection point cloud are obtained on the basis of the X/Y/Z-coordinate value of each detection point in the region of interest ROI illustrated in FIG. 10. In this example, a section is provided every 0.1 m with respect to the center of the region of interest ROI, and the maximum reflection energy value of the detection point cloud belonging to each section is obtained and formed into a histogram. In FIG. 13, a similar process is performed on each detection point in the region of interest ROI illustrated in FIG. 11.

As can be seen from a comparison between FIG. 12 and FIG. 13, in FIG. 12 illustrating a case where there is an obstacle, there is a tendency that at least (a) has a clear peak in the histogram, and (b) and (c) each have a high bin height as a whole. On the other hand, in FIG. 13 illustrating a case where there are no obstacles, there is no tendency (or there is a small tendency) of such a histogram to have a clear peak or a great bin height as a whole. Therefore, it can be seen that the presence or absence of an obstacle can be determined with high accuracy, on the basis of such feature amounts.

Next, examples of a feature vector are described with reference to FIG. 14. FIG. 14 is a diagram illustrating examples of a feature vector created in the embodiment. In step S44 in FIG. 7, as a pre-stage process for determining the presence or absence of an obstacle, a process of creating a feature vector from the feature amounts extracted from the distribution form of the detection point cloud is performed.

FIG. 14A illustrates a feature vector corresponding to FIG. 12. FIG. 14B illustrates a feature vector corresponding to FIG. 13. Here, the feature vectors created by simply connecting the extracted feature amounts are illustrated as examples. Specifically, since each of the three histograms included nine sections, the created feature vector had a length of 27 dimensions.

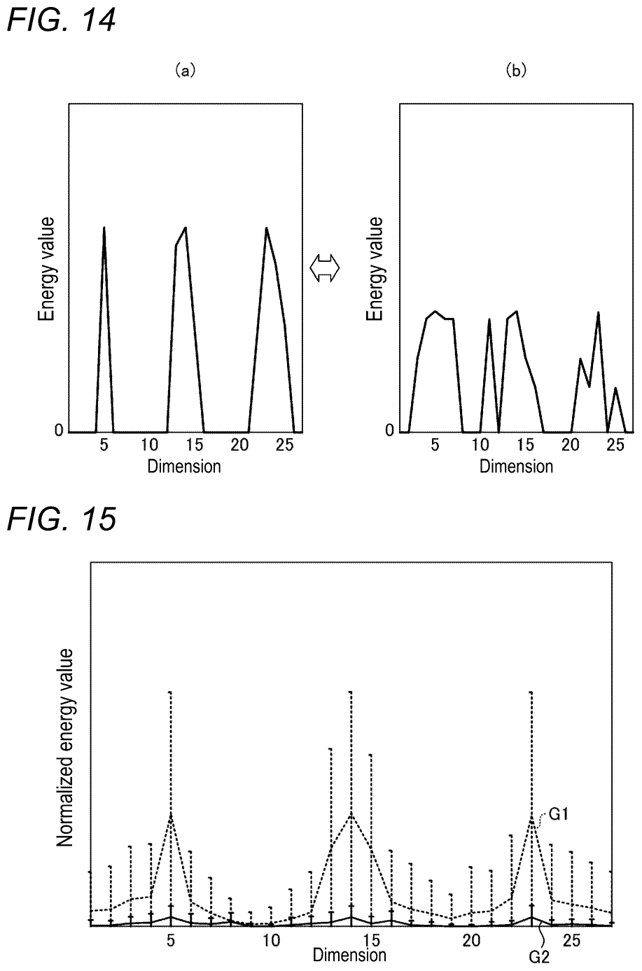

Next, FIG. 15 is a graph for comparing two feature vectors in the embodiment. That is, FIG. 15 is a graph in which the feature vectors based on the detection point clouds obtained from tests under the conditions with and without the obstacle accumulated in the past are superimposed for comparison. A graph G1 is the average of the feature vectors obtained under the condition with an obstacle. Also, a graph G2 is the average of the feature vectors obtained under the condition without an obstacle. Further, error bars corresponding to the respective graphs indicate the standard deviations. Furthermore, each feature vector is normalized on the basis of the maximum amplitude of all the feature vectors.

Here, under the condition with an obstacle, detection data was obtained when an obstacle such as a person, a vehicle, a staircase, a metal pole, a triangular cone, or a curb was installed at a position 0.2 m to 1.4 m away from the door. A clear difference in the size and shape of the feature vector can be found between both conditions.

To determine the presence or absence of an obstacle, it is important to create the feature vectors so that the difference between the feature vectors becomes clear as described above. If necessary, not only simple connection as in the above example, but also a process of creating a new feature amount from these feature amounts, which is called feature amount engineering, may be added. As the feature amount engineering, for example, an edge enhancement process or the like can be considered. By this process, edges are enhanced, and the accuracy of determination as to the presence or absence of an obstacle may be further increased in some cases.

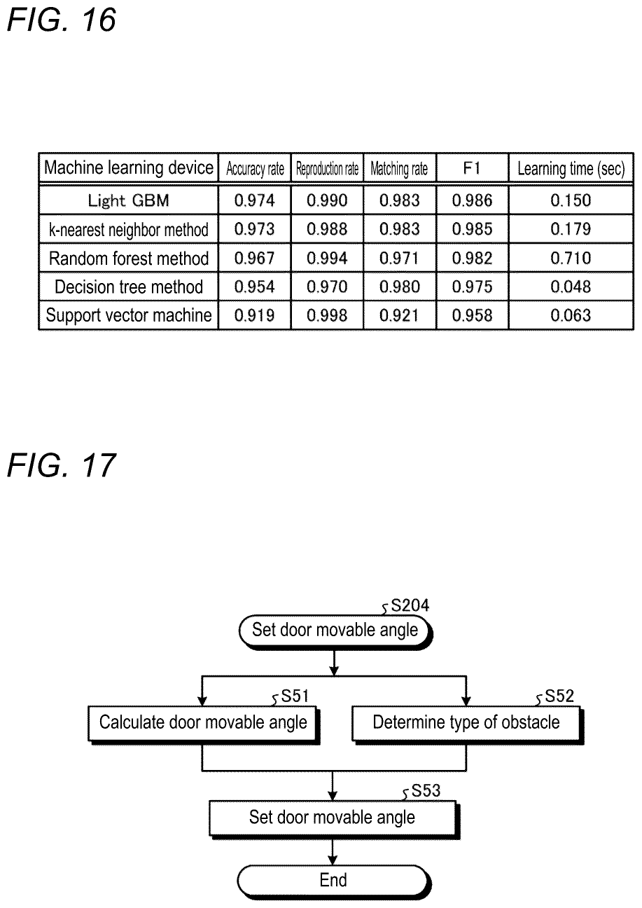

Next, performance of a plurality of machine learning devices determining the presence or absence of an object is described with reference to FIG. 16. FIG. 16 is a comparison table showing performance of a plurality of machine learning devices determining the presence or absence of an object in the embodiment.

In step S45 in FIG. 7, a process of determining the presence or absence of an obstacle is performed using a machine learning device. In FIG. 16, the presence or absence of an obstacle is learned on the basis of the feature vector cloud illustrated in FIG. 15 with typical machine learning devices such as a Light Gradient Boosting Machine (LightGBM), a k-nearest neighbor algorithm, a random forest algorithm, a decision tree algorithm, and a support vector machine, and the results of a determination test are shown.

The numbers in the table indicate the average value of each index after execution of 10-fold cross-validation. The rate of accuracy of determination varies depending on the machine learning device that was used, and the lowest accuracy rate was 91.9%, which was achieved in the case where a support vector machine was used. The highest was 97.4%, which was achieved in the case where a LightGBM was used.

Indexes such as reproduction rate, matching rate, and F1 in determination also varied in accuracy, possibly reflecting the properties of each machine learning device. Further, the learning time also varied greatly from 0.048 seconds to 0.710 seconds each time. Note that a standard Windows (registered trademark)-based computer was used for this calculation.

These results suggest that, with the use of a machine learning device, it is possible to determine whether an obstacle that hinders an opening operation of an automatic door actually exists with very high accuracy, on the basis of the distribution form of the detection point cloud data captured by the millimeter wave radar 32. In selecting a machine learning device, it is considered that a machine learning device that can achieve a higher determination accuracy in shorter learning and estimation times should be selected, while the performance of the DSP 31 that can be mounted in the vehicle 1 is taken into consideration.

Meanwhile, no matter how good the feature amount extraction and the feature amount engineering are performed, it may be difficult to create a machine learning device that can constantly achieve an accuracy rate of 100% in one determination process. In this case, final determination may be performed after the determination results obtained in a plurality of cycles in the past are integrated. For example, a machine learning device having an accuracy rate of 97% in one determination process has a 3% probability of giving false positive and false negative answers, but has a 0.09% probability of making erroneous determination twice in a row. The probability of making erroneous determination three times in a row is only 0.0027%. By introducing this device, it can be expected that the determination as to the presence or absence of an obstacle can be performed at an accuracy rate of almost 100%.

Further, although the determination as to the presence or absence of an obstacle using a single machine learning device has been described above, it is possible to use an ensemble learning method by which determination using a plurality of machine learning devices is performed in parallel to obtain a concerted result. In that case, the bias and the variance of determination are minimized, and thus, there is a possibility that the determination accuracy can be further increased.

Next, the process in step S204 in FIG. 5 is described in detail, with reference to FIG. 17. FIG. 17 is a flowchart illustrating details of the process in step S204 in FIG. 5.

In step S204, a process of calculating the door movable angle is performed to determine whether there is still room to continue the opening operation before the door 21 collides with the obstacle. Here, if the door movable angle=0, the door 21 will collide with the obstacle.

In step S51, the control part 56 of the DSP 31 calculates the door movable angle on the basis of the positional information about the obstacle.

Further, in step S52, the control part 56 determines the type of the obstacle.

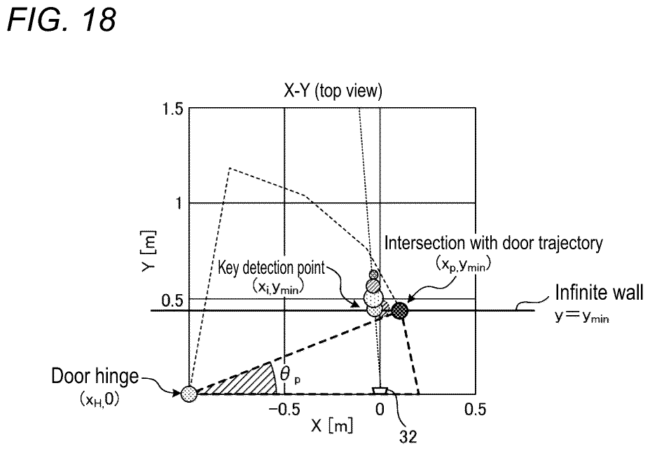

Here, FIG. 18 is an explanatory diagram of calculation of the door movable angle in the embodiment. First, the calculation starts from determination of a key detection point. As the key detection point, it is preferable to select the detection point closest to the door 21. However, there is a possibility that a noise detection point appearing in front of the actual obstacle position will be selected. Therefore, the detection point closest to the door 21 is selected from among the detection points having reflection energy values equal to or greater than a certain threshold, for example, so that the possibility can be reduced.

Subsequently, a virtual infinite wall (y=yₘᵢₙ) is set on the basis of the distance (Y-coordinate value) to the key detection point from the door 21. For example, the space sandwiched between the infinite wall and the current position of the door 21 is determined to be the space in which the opening operation of the door 21 can be continued. However, when the space is determined in this manner, there is a problem in that an obstacle existing closer to the hinge side of the door 21 has less room for continuing the opening operation. This is a safe and effective countermeasure to deal with the fundamental problem for the millimeter wave radar 32 having difficulty to accurately detect the spread of an obstacle.

Using the intersection (xₚ, yₘᵢₙ) of the infinite wall and the trajectory (black broken line) of opening of the door 21, the door hinge (x_{H}, 0), and the door surface, the angle θₚ illustrated in FIG. 18 is calculated as the movable angle according to (Expression 1) shown below.

### [Math. 1]

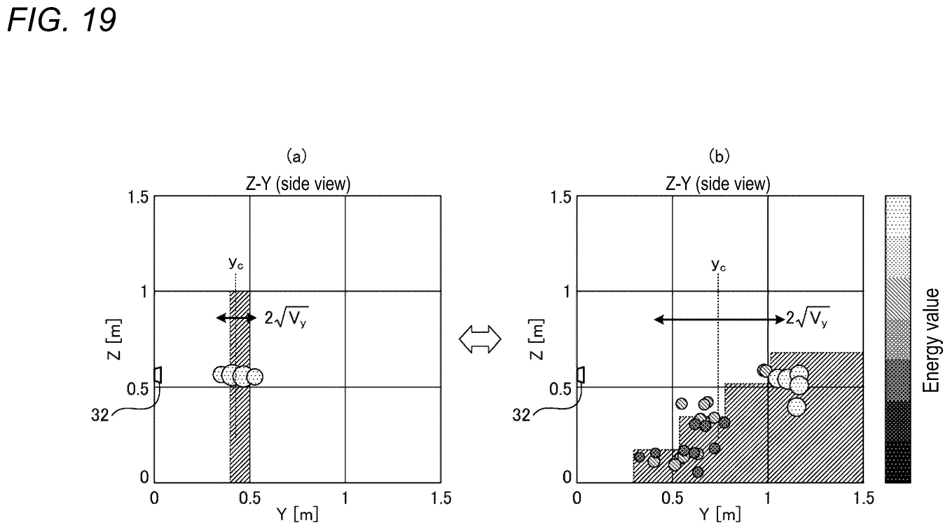

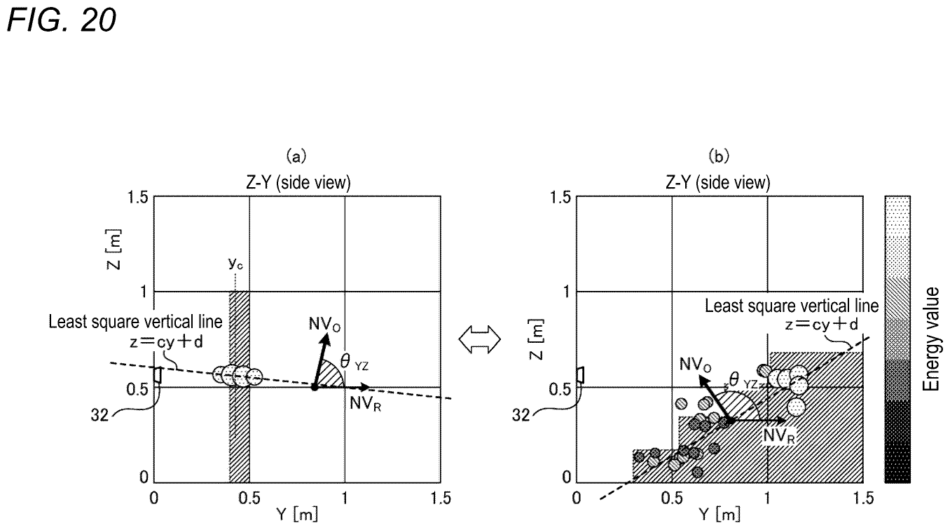

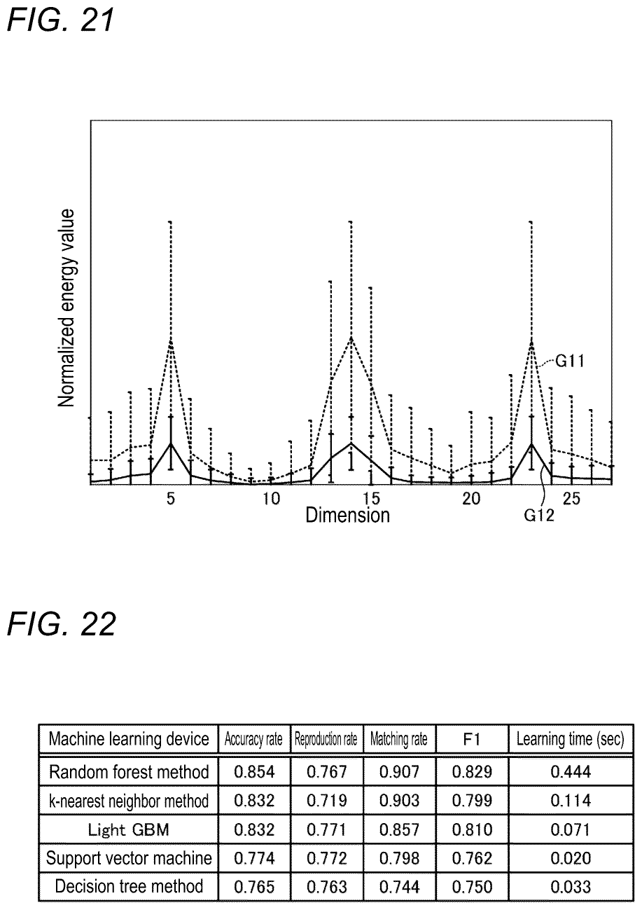

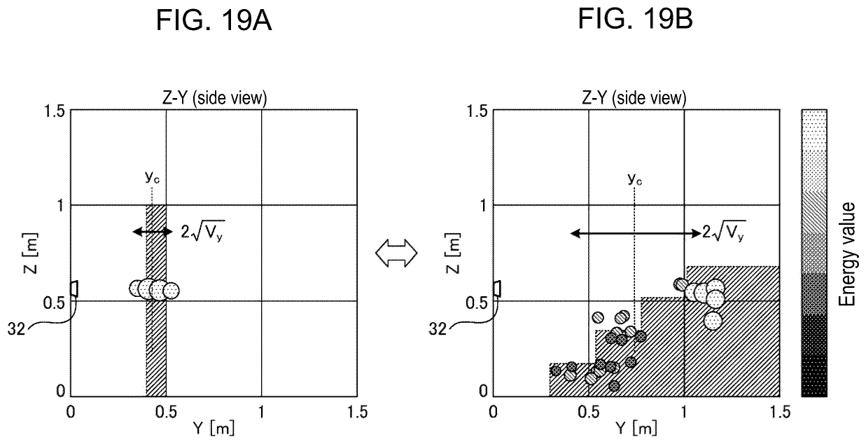

Next, FIGS. 19A-19B is an explanatory diagram of object type determination based on statistics of distributions of detection point clouds in the embodiment. In step S52 in FIG. 17, a process of determining the type of the obstacle is performed, on the basis of the distribution form of the detection point cloud. Although various types of methods are conceivable, three types of determination methods will be described below as examples. Note that the obstacle type determination does not have to be based on a result of implementation of each individual method, but the methods may be combined as necessary.

### (Type Determination Method 1) Determination Based on Statistics of Distributions of Detection Point Clouds

There is a difference in the distribution form of the detection point cloud between an obstacle such as a metal pole having a small width and a small depth (a gray portion in FIG. 19A) and an obstacle such as a staircase having a great width and a great depth (a gray portion in FIG. 19B). In the description below, for the sake of convenience, the former will be referred to as a simple shape, and the latter will be referred to as a complex shape in the continued description.

In a simple shape, the detection point cloud is locally distributed in a narrow region. On the other hand, in a complex shape, the detection point cloud tends to be distributed and spread to a certain extent. Therefore, both shapes are determined in accordance with the statistics of distributions.

For example, the variance values (Vₓ, V_{y}, V_{z}) of detection point cloud data are calculated using (Expression 2) and (Expression 3) shown below. Here, N represents the number of pieces of detection point cloud data, and (x_{c}, y_{c}, z_{c}) represents the center of the distribution.

### [Math. 2]

Further, as shown Expression (4) below, the variance value (V_{y}, for example) of the detection point cloud data is compared with a threshold THD_V_{y}. In a case where the variance value is smaller than the threshold THD_V_{y}, the detection point cloud data is determined to be of a simple shape. In a case where the variance value is greater than the threshold THD_V_{y}, the detection point cloud data is determined to be of a complex shape.

if (V_{y} < THD_V_{y}), (Expression 4)
# the obstacle has a simple shape,
else
# the obstacle has a complex shape

### (Type Determination Method 2) Determination Based on Geometric Features of Distributions of Detection Point Clouds

The difference in the distribution of the detection point cloud between a simple shape and a complex shape is as described above. However, from a different viewpoint, the two are determined on the basis of geometric features.

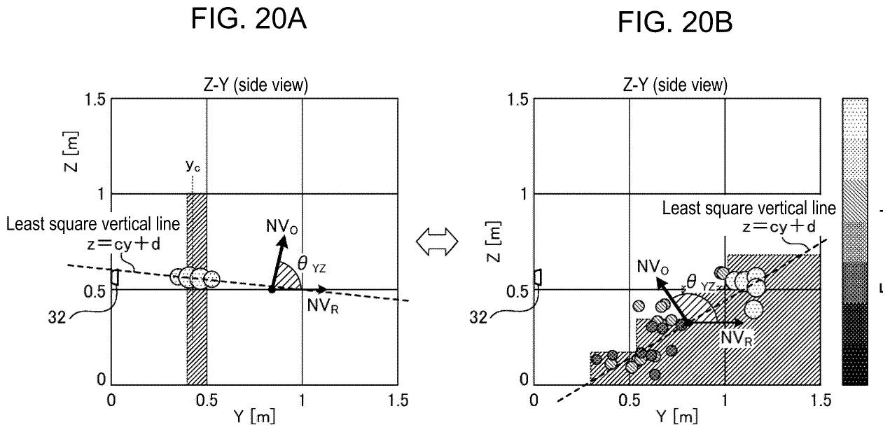

FIGS. 20A-20B is an explanatory diagram of object type determination based on geometric features of distributions of detection point clouds in the embodiment. For example, a least square line shown in (Expression 5) below is obtained from the distribution form of a detection point cloud in the Y-Z plane. Further, the coefficients c and d in the least square line are obtained by solving (Expression 6). Here, wi represents a weighting coefficient. A normalized value of reflection energy at each detection point is adopted, so that a least square line reflecting the intensity can be obtained.

### [Math. 3]

Subsequently, the unit normal vector NVₒ of the least square line of (Expression 5) is calculated according to (Expression 7). Further, the angle θ_{YZ} formed by the unit normal vector NV_{R}=(1,0) of the radar surface is calculated according to (Expression 8).

### [Math. 4]

Subsequently, as shown in Expression (9), the angle θ_{YZ} is compared with a threshold section [THD_θ_{YZ1}, THD_θ_{YZ2}]. In a case where the angle θ_{YZ} is within the section, the shape is determined to be a simple shape. In a case where the angle θ_{YZ} is out of the section, the shape is determined to be a complex shape.

if (THD_θ_{YZ1}) < θ_{YZ}) and (θ_{YZ} < THD_θ_{YZ2}), (Expression 9)
# the obstacle has a simple shape,
else
# the obstacle has a complex shape

### (Type Determination Method 3) Determination Based on Reflection Energy Values of Distributions of Detection Point Clouds

As a fundamental feature of the millimeter wave radar 32, the reflection energy value is detected as a smaller value when the material thereof has a smaller radar cross-sectional area and is less likely to reflect waves (example: plastic resin). Conversely, the reflection energy value is detected as a greater value when the material thereof has a larger radar cross-sectional area and is less likely to reflect waves (example: iron). According to the above classification, the former corresponds to a simple shape, and the latter corresponds to a complex shape. Therefore, determination is performed on the basis of reflection energy values.

FIG. 21 is an explanatory diagram of object type determination based on reflection energy values of distributions of detection point clouds in the embodiment. The discrimination method in this case uses a machine learning technique. For example, processes similar to those in steps S41 to S44 in FIG. 7 were performed for each piece of detection data, to compare a feature vector G12 obtained from an obstacle classified as a simple shape (examples: a metal pole, a triangular cone, a curb, and the like) with a feature vector G11 obtained from an obstacle classified as a complex shape (examples: a person, a vehicle, a staircase, and the like). As a result, there were differences as illustrated in FIG. 21. Note that error bars corresponding to the respective graphs indicate the standard deviations.

Here, FIG. 22 is a comparison table showing performance of a plurality of machine learning devices determining object types in the embodiment. When a process similar to that in step S45 in FIG. 7 was performed to attempt to determine the types of new (unlearned) data using machine learning devices that had learned the past data, simple shapes and complex shapes were determined with a highest accuracy rate of 85.4%.

Referring back to FIG. 17, after steps S51 and S52, in step S53, the control part 56 of the DSP 31 performs a process of determining and setting the final door movable angle as appropriate by combining the results of steps S51 and S52.

For example, in the case of an obstacle having a simple shape with which the damage is estimated to be small even if a collision with the obstacle occurs, it is possible to determine to operate at the calculated door movable angle. Conversely, in the case of an obstacle having a complex shape with which the damage is estimated to be serious if a collision with the obstacle occurs, the door movable angle can be determined to be a very small angle (so that only a pop-up (an operation of unlocking and freeing the door 21) is performed, for example).

As described above, with the automatic door system S of the present embodiment, an object detection model generated beforehand by machine learning is used, so that an obstacle around the vehicle 1 can be detected with high accuracy, regardless of the surrounding environments such as the road surface.

Further, a more specific process of calculating the feature vector indicating the distribution shape of a detection point cloud by setting a region of interest (FIG. 10, FIG. 11) in three-dimensional coordinates based on the door can be performed.

Also, the door 21 is made to perform an opening operation up to the set opening movable angle, so that a collision between the door 21 and an obstacle can be avoided, and the door 21 is prevented from stopping the opening operation at an unnecessarily early stage.

Furthermore, the user of the vehicle can conduct a predetermined operation in response to a request for an automatic opening operation of the door 21, so that the door 21 can be made to perform an opening operation.

Although an embodiment of the present disclosure has been described so far as an example, the above embodiment and modifications are merely examples, and are not intended to limit the scope of the disclosure. The above embodiment and modifications can be implemented in various other modes, and various omissions, replacements, and changes can be made to them, without departing from the spirit of the disclosure. Also, the configurations and shapes according to the embodiment and modifications can be partially interchanged.

For example, in the above embodiment, the automatic door system S includes one ECU 23 (FIG. 2), but the present disclosure is not limited to this. The automatic door system S may include a plurality of ECUs.

Also, one of the functions of the DSP 31 (for example, the model generation part 52) may be included in the ECU 23.

Further, the least square line is taken as an example in FIGS. 20A-20B, but the present disclosure is not limited to this, and a least square curve or a least square curved surface may be used.

Furthermore, the object detection sensor is not necessarily a millimeter wave radar, and may be some other type of sensor such as an ultrasonic sensor.

Also, data of the feature vector newly determined by machine learning may be updated as a comparison target at the time of the next comparison.

Further, in the above embodiment, the target in which an object detection sensor is installed is the vehicle 10. However, the present disclosure is not limited to this. Targets in which an object detection sensor is installed are all general mobile objects including mobile robots and the like whose surrounding environments change from moment to moment because of movement.

### REFERENCE SIGNS LIST

1: Vehicle, 2: Automatic door unit, 3: Sensor unit, 4: In-vehicle network, 5: Processing unit, 6: Storage unit, 21: Door, 22: Door drive unit, 23: ECU, 31: DSP, 32: Millimeter wave radar, 51: Acquisition part, 52: Model generation part, 53: First calculation part, 54: Second calculation part, 55: Estimation part, 56: Control part, and S: Automatic door system

1. An object detection device comprising:
an acquisition part that acquires a plurality of results of reception of a reflected wave generated when a probing wave transmitted from a sensor installed in a door of a vehicle is reflected by an object around the vehicle; and,
in a learning phase,
a model generation part that calculates a detection point cloud as a position of the object on a basis of the plurality of results of reception acquired by the acquisition part, and generates an object detection model by performing machine learning of a relationship between a feature vector indicating a distribution shape of the detection point cloud and information indicating whether the object is an obstacle;
in an estimation phase,
a first calculation part that calculates a detection point cloud as a position of the object, on a basis of the plurality of results of reception acquired by the acquisition part;
a second calculation part that calculates a feature vector indicating a distribution shape of the detection point cloud, on a basis of the detection point cloud calculated by the first calculation part; and
an estimation part that determines whether the object is an obstacle on a basis of the feature vector calculated by the second calculation part and the object detection model, and outputs a determination result.

2. The object detection device according to claim 1, wherein
the model generation part performs coordinate transform of the detection point cloud into three-dimensional coordinates based on the door in which the sensor is installed, sets at least one region of interest on a basis of the detection point cloud in the three-dimensional coordinates, and calculates, as input data, a feature vector indicating a distribution shape of the detection point cloud in the set region of interest, and
the second calculation part performs coordinate transform of the detection point cloud calculated by the first calculation part into the three-dimensional coordinates, sets at least one region of interest on a basis of the detection point cloud in the three-dimensional coordinates, and calculates a feature vector indicating a distribution shape of the detection point cloud in the set region of interest.

3. The object detection device according to claim 1, wherein
the door is a swing door,
the object detection device further includes a control part that controls a driver unit that causes the door to perform an opening or closing operation, and,
when the estimation part outputs information indicating that the object is an obstacle, the control part sets an opening movable angle of the door on a basis of positional information about the obstacle, and controls the drive unit to cause the door to perform an opening operation to the set opening movable angle.

4. The object detection device according to claim 3, wherein the control part controls the drive unit to cause the door to perform an opening operation to the set opening movable angle, on a basis of a request for an automatic opening operation of the door from a user of the vehicle.

5. An object detection method comprising:
an acquisition step of acquiring a plurality of results of reception of a reflected wave generated when a probing wave transmitted from a sensor installed in a door of a vehicle is reflected by an object around the vehicle; and,
in a learning phase,
a model generation step of calculating a detection point cloud as a position of the object on a basis of the plurality of results of reception acquired in the acquisition step, and generating an object detection model by performing machine learning of a relationship between a feature vector indicating a distribution shape of the detection point cloud and information indicating whether the object is an obstacle;
in an estimation phase,
a first calculation step of calculating a detection point cloud as a position of the object, on a basis of the plurality of results of reception acquired in the acquisition step;
a second calculation step of calculating a feature vector indicating a distribution shape of the detection point cloud, on a basis of the detection point cloud calculated in the first calculation step; and
an estimation step of determining whether the object is an obstacle on a basis of the feature vector calculated in the second calculation step and the object detection model, and outputting a determination result.

6. An object detection method comprising:
an acquisition step of acquiring a plurality of results of reception of a reflected wave generated when a probing wave transmitted from a sensor installed in a swing door of a vehicle is reflected by an object around the vehicle; and,
in a learning phase,
a model generation step of calculating a detection point cloud as a position of the object on a basis of the plurality of results of reception acquired in the acquisition step, and generating an object detection model by performing machine learning of a relationship between a feature vector indicating a distribution shape of the detection point cloud and information indicating whether the object is an obstacle;
in an estimation phase,
a first calculation step of calculating a detection point cloud as a position of the object, on a basis of the plurality of results of reception acquired in the acquisition step;
a second calculation step of calculating a feature vector indicating a distribution shape of the detection point cloud, on a basis of the detection point cloud calculated in the first calculation step;
an estimation step of determining whether the object is an obstacle on a basis of the feature vector calculated in the second calculation step and the object detection model, and outputting a determination result; and
a control step of, when information indicating that the object is an obstacle is output from the estimation step, setting an opening movable angle of the door on a basis of positional information about the obstacle, and controlling a drive unit that causes the door to open or close, to cause the door to perform an opening operation to the set opening movable angle.
